(19) United States
(12) Patent Application Publication
(10) Pub. No.: US 2007/0151961 A1
(43) Pub. Date: Jul. 5, 2007

(54) Fabrication of an implantable medical device with a modified laser beam

(76) Inventors: Klaus Kleine, Los Gatos, CA (US); David C. Gale, San Jose, CA (US)

Correspondence Address: SQUIRE, SANDERS & DEMPSEY LLP, 1 MARITIME PLAZA, SUITE 300, SAN FRANCISCO, CA, 94111, US

(21) Appl. No.: 11/325,069

(22) Filed: Jan. 3, 2006

(51) Int. Cl. B23K 26/38

(52) U.S. Cl. 219/121.72; 219/121.73

(57) ABSTRACT

Embodiments of methods and systems for laser machining a substrate in the fabrication of an implantable medical device are disclosed.

### BACKGROUND OF THE INVENTION

1. Field of the Invention

This invention relates to fabricating an implantable medical device with laser machining. In particular, the invention relates to fabricating implantable medical devices with a modified laser beam.

2. Description of the State of the Art

This invention relates to laser machining of implantable medical devices such as stents. Laser machining refers to removal of material accomplished through laser and target material interactions. Generally speaking, these processes include laser drilling; laser cutting; and laser grooving, marking, or scribing. Laser machining processes transport photon energy into a target material in the form of thermal energy or photochemical energy. Material is removed by melting and blowing away, or by direct vaporization/ablation.

The application of ultrashort-pulse lasers for high quality laser material processing is particularly useful due to the extremely high intensity (>10¹² W/cm²), ultrashort-pulse duration (<1 picosecond), and non-contact nature of the processing. Ultrashort lasers allow precise and efficient processing, especially at the microscale. Compared with long-pulse lasers and other conventional manufacturing techniques, ultrashort lasers provide precise control of material removal, can be used with an extremely wide range of materials, produce negligible thermal damage, and provide the capability for very clean small features. These features make ultrashort-pulse lasers a promising tool for microfabrication, thin film formation, laser cleaning, and medical and biological applications.

One of the many medical applications for laser machining includes fabrication of radially expandable endoprostheses, which are adapted to be implanted in a bodily lumen. An “endoprosthesis” corresponds to an artificial device that is placed inside the body. A “lumen” refers to a cavity of a tubular organ such as a blood vessel.

A stent is an example of such an endoprosthesis. Stents are generally cylindrically shaped devices, which function to hold open and sometimes expand a segment of a blood vessel or other anatomical lumen such as urinary tracts and bile ducts. Stents are often used in the treatment of atherosclerotic stenosis in blood vessels. “Stenosis” refers to a narrowing or constriction of the diameter of a bodily passage or orifice. In such treatments, stents reinforce body vessels and prevent restenosis following angioplasty in the vascular system. “Restenosis” refers to the reoccurrence of stenosis in a blood vessel or heart valve after it has been treated (as by balloon angioplasty, stenting, or valvuloplasty) with apparent success.

The treatment of a diseased site or lesion with a stent involves both delivery and deployment of the stent. “Delivery” refers to introducing and transporting the stent through a bodily lumen to a region, such as a lesion, in a vessel that requires treatment. “Deployment” corresponds to the expanding of the stent within the lumen at the treatment region. Delivery and deployment of a stent are accomplished by positioning the stent about one end of a catheter, inserting the end of the catheter through the skin into a bodily lumen, advancing the catheter in the bodily lumen to a desired treatment location, expanding the stent at the treatment location, and removing the catheter from the lumen.

In the case of a balloon expandable stent, the stent is mounted about a balloon disposed on the catheter. Mounting the stent typically involves compressing or crimping the stent onto the balloon. The stent is then expanded by inflating the balloon. The balloon may then be deflated and the catheter withdrawn. In the case of a self-expanding stent, the stent may be secured to the catheter via a retractable sheath or a sock. When the stent is in a desired bodily location, the sheath may be withdrawn which allows the stent to self-expand.

The stent must be able to satisfy a number of mechanical requirements. First, the stent must be capable of withstanding the structural loads, namely radial compressive forces, imposed on the stent as it supports the walls of a vessel. Therefore, a stent must possess adequate radial strength. Radial strength, which is the ability of a stent to resist radial compressive forces, is due to strength and rigidity around a circumferential direction of the stent. Radial strength and rigidity, therefore, may also be described as, hoop or circumferential strength and rigidity.

Once expanded, the stent must adequately maintain its size and shape throughout its service life despite the various forces that may come to bear on it, including the cyclic loading induced by the beating heart. For example, a radially directed force may tend to cause a stent to recoil inward. Generally, it is desirable to minimize recoil.

In addition, the stent must possess sufficient flexibility to allow for crimping, expansion, and cyclic loading. Longitudinal flexibility is important to allow the stent to be maneuvered through a tortuous vascular path and to enable it to conform to a deployment site that may not be linear or may be subject to flexure. Finally, the stent must be biocompatible so as not to trigger any adverse vascular responses.

The structure of a stent is typically composed of scaffolding that includes a pattern or network of interconnecting structural elements often referred to in the art as struts or bar arms. The scaffolding can be formed from wires, tubes, or sheets of material rolled into a cylindrical shape. The scaffolding is designed so that the stent can be radially compressed (to allow crimping) and radially expanded (to allow deployment).

Stents have been made of many materials such as metals and polymers, including biodegradable polymeric materials. Biodegradable stents are desirable in many treatment applications in which the presence of a stent in a body may be necessary for a limited period of time until its intended function of, for example, achieving and maintaining vascular patency and/or drug delivery is accomplished.

Stents can be fabricated by forming patterns on tubes or sheets using laser machining. Laser machining is well-suited to forming the fine intricate patterns of structural elements in stents.

However, a problem with laser machining, particularly with polymers, is a tendency for the formation of a heat affected zone on the substrate. The heat affected zone is a region on the target material that is not removed, but is affected by heat due to the laser beam. The properties of material in the zone can be adversely affected by heat from the laser beam. Therefore, it is generally desirable to reduce or eliminate heat input beyond the removed material, thus reducing or eliminating the heat affected zone.

### SUMMARY OF THE INVENTION

Certain embodiments of the present invention are directed to a method of fabricating an implantable medical device that may include modifying a laser beam having a Gaussian-shaped radial intensity profile with an optical system to have a flat-top radial intensity profile. The method may further include removing material from a substrate with the modified beam to form an implantable medical device.

Further embodiments of the present invention are directed to a method of fabricating an implantable medical device that may include modifying an intensity of a laser beam with an optical system such that the modified intensity is uniform or substantially uniform over a majority of a radial cross-section of the modified beam. The method may further include removing material from a substrate with the modified beam to form an implantable medical device.

Additional embodiments of the present invention are directed to a method of fabricating an implantable medical device that may include modifying an intensity of a laser beam with an optical system so that the portion of a radial cross-section of the beam having an intensity greater than a selected value is increased. The method may further include removing material from a substrate with the modified beam to form an implantable medical device.

Additional embodiments of the present invention are directed to a system for fabricating an implantable medical device that may include a laser beam source that generates a beam having a nonuniform radial intensity profile. The system may further include a refractive optical system for modifying the beam such that the refractive optical system is capable of modifying the beam to have a more uniform radial intensity profile. The system may also include a fixture for holding a substrate. The laser beam source may be positioned to direct the beam from the laser beam source through the optical system so that the modified beam removes material from the substrate held by the fixture.

### BRIEF DESCRIPTION OF THE DRAWINGS

FIG. 1 depicts a three-dimensional representation of a stent.

FIG. 2 depicts a Gaussian laser beam profile.

FIG. 3 depicts a collimated two-dimensional representation of a laser beam.

FIG. 4 depicts an overhead view of the surface of a substrate.

FIG. 5 illustrates a kerf machined by a laser.

FIG. 6 depicts a Gaussian radial intensity profile and a flat-top radial intensity profile.

FIG. 7 depicts an exemplary embodiment of a refractive optical system.

FIG. 8 depicts an exemplary embodiment of a refractive optical system with a single aspheric lens.

FIG. 9 depicts an embodiment of a portion of a machine-controlled system for laser machining a tube.

FIG. 10 depicts a general schematic of a laser system.

FIG. 11 depicts a side view of a laser machining apparatus.

FIG. 12 depicts an overhead view of a laser machining apparatus.

FIG. 13 depicts a close-up axial view of a region where a laser beam interacts with a tube.

FIG. 14 depicts a close-up end view of a region where a laser beam interacts with a tube.

### DETAILED DESCRIPTION OF THE INVENTION

Embodiments of the present invention relate to fabricating implantable medical devices, such as stents, using laser machining. These embodiments may be used to fabricate implantable medical devices including, but not limited to, balloon expandable stents, self-expandable stents, stent-grafts, and grafts (e.g., aortic grafts).

As indicated above, stents are generally cylindrically shaped devices, which function to hold open and sometimes expand a segment of a blood vessel or other anatomical lumen. In general, stents can have virtually any structural pattern that is compatible with a bodily lumen in which it is implanted. Typically, a stent is composed of a pattern or network of circumferential rings and longitudinally extending interconnecting structural elements of struts or bar arms. In general, the struts are arranged in patterns, which are designed to contact the lumen walls of a vessel and to maintain vascular patency. A myriad of strut patterns are known in the art for achieving particular design goals. A few of the more important design characteristics of stents are radial or hoop strength, expansion ratio or coverage area, and longitudinal flexibility.

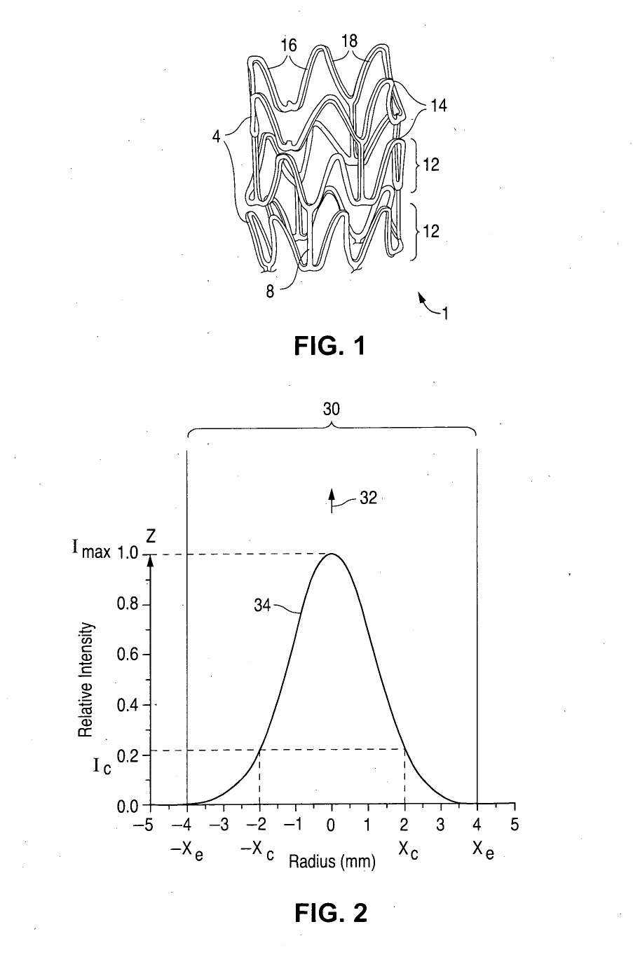

FIG. 1 depicts a three-dimensional view of an exemplary embodiment of a cylindrically-shaped stent 1 with struts 4 that form cylindrical rings 12 which are connected by linking struts 8. The cross-section of the struts in stent 1 is rectangular-shaped. The struts have abluminal faces 14, luminal faces 16, and sidewall faces 18. The cross-section of struts is not limited to what has been illustrated, and therefore, other cross-sectional shapes are applicable with embodiments of the present invention. The pattern should not be limited to what has been illustrated as other stent patterns are easily applicable with embodiments of the present invention.

In general, a stent pattern is designed so that the stent can be radially expanded (to allow deployment) and crimped (to allow delivery). The stresses involved during expansion from a low profile to an expanded profile are generally distributed throughout various structural elements of the stent pattern. As a stent expands, various portions of the stent can deform to accomplish a radial expansion.

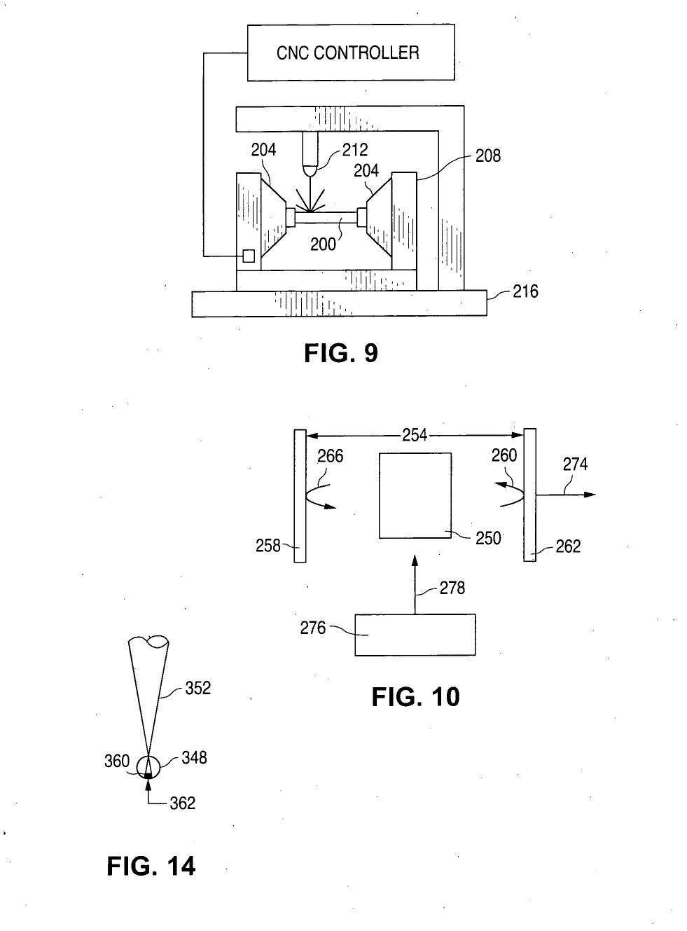

Stents and similar stent structures can be made in a variety of ways. A stent may be fabricated by machining a thin-walled tubular member with a laser. Selected regions of the tubing may be removed by laser machining to obtain a stent with a desired pattern. Alternatively, a stent may be fabricated by machining a sheet in a similar manner, followed by rolling and bonding the cut sheet to form the stent. The tubing may be cut using a machine-controlled laser as illustrated schematically in FIG. 9. Laser machining may be used to fabricate stents from a variety of materials. For example, a stent pattern may be cut into materials including polymers, metals, or a combination thereof.

In many treatment applications, the presence of a stent in a body may be necessary for a limited period of time until its intended function of, for example, maintaining vascular patency and/or drug delivery is accomplished. Thus, it may be desirable for a stent to be biodegradable. Stents fabricated from biodegradable, bioabsorbable, and/or bioerodable materials such as bioabsorbable polymers can be configured to completely erode only after the clinical need for them has ended.

In general, polymers can be biostable, bioabsorbable, biodegradable, or bioerodable. Biostable refers to polymers that are not biodegradable. The terms biodegradable, bioabsorbable, and bioerodable, as well as degraded, eroded, and absorbed, are used interchangeably and refer to polymers that are capable of being completely eroded or absorbed when exposed to bodily fluids such as blood and can be gradually resorbed, absorbed, and/or eliminated by the body. In addition, a medicated stent may be fabricated by coating the surface of the stent with an active agent or drug, or a polymeric carrier including an active agent or drug. An active agent can also be incorporated into the scaffolding of the stent.

A stent made from a biodegradable polymer is intended to remain in the body for a duration of time until its intended function of, for example, maintaining vascular patency and/or drug delivery is accomplished. After the process of degradation, erosion, absorption, and/or resorption has been completed, no portion of the biodegradable stent, or a biodegradable portion of the stent will remain. In some embodiments, very negligible traces or residue may be left behind. The duration can be in a range from about a month to a few years. However, the duration is typically in a range from about one month to twelve months, or in some embodiments, six to twelve months.

Embodiments of the present invention are applicable to laser machining with virtually any type of laser, including, but not limited to an excimer, carbon dioxide, and YAG. Additionally, the embodiments are not limited to lasers of any particular pulse length. For example, “ultrashort-pulse lasers” refer to lasers having pulses with durations shorter than about a picosecond (=10⁻¹²). Ultrashort-pulse lasers can include both picosecond and femtosecond (=10⁻¹⁵) lasers. The ultrashort-pulse laser is clearly distinguishable from conventional continuous wave and long-pulse lasers (nanosecond (10⁻⁹) laser) which have significantly longer pulses. Certain embodiments may employ femtosecond lasers that may have pulses shorter than about 10⁻¹³ second.

Ultrashort-pulse lasers are known to artisans. For example, they are thoroughly disclosed by M. D. Perry et al. in Ultrashort-Pulse Laser Machining, Section K-ICALEO 1998, pp.1-20. Representative examples of femtosecond lasers include, but are not limited to a Ti:sapphire laser (735 nm-1035 nm) and an excimer-dye laser (220 nm-300 nm, 380 nm-760 nm). An advantage of ultrashort-pulse lasers over longer-pulse lasers is that the ultrashort-pulse deposits its energy so fast that is does not interact with the plume of vaporized material, which would distort and bend the incoming beam and produce a rough-edged cut.

Even ultrashort-pulse laser machining tends to produce a heat affected zone, i.e., a portion of the target substrate that is not removed, but is still heated by the beam. The heating may be due to exposure to the substrate from a section of the beam with an intensity that is not great enough to remove substrate material through either a thermal or nonthermal mechanism. A primary cause of a heat affected zone is a nonuniform illumination of a machined substrate. Thus, it would be advantageous to laser machine a substrate with a laser beam that allows a more uniform illumination of an area of the substrate.

It is generally known by those of skill in the art of lasers and laser-machining that the typical intensity distribution of a laser beam is not uniform. The beam emitted by many lasers has a radial intensity dependence that follows a Gaussian profile. For example, the radial intensity dependence is proportional to exp(−2r²/w₀²), where r is the radial distance and w₀ is a beam-waist parameter that determines the size of the beam.

FIG. 2 depicts an axial cross-section of an exemplary laser beam 30 traveling in the “z” direction as indicated by an arrow 32. A mathematical representation 34 of beam intensity in the form of a Gaussian beam profile is shown superimposed on beam 30. The profile has a maximum intensity (Iₘₐₓ) at the beam center (x=0) and then decreases gradually with distance on either side of the maximum. Below a critical intensity level (I_{c}) or range of intensity, the intensity of the beam is not great enough to remove material from a substrate. Portions of the beam close to its edge (−xₑ and xₑ) may not remove material from the substrate.

As shown in FIG. 2, material is not removed above approximately x_{c} and below approximately −x_{c}. However, portions of the beam not strong enough to remove material may still deposit energy into the material that can have undesirable thermal affects. Additionally, a portion of the substrate may also be heated through conduction. For example, a portion of the substrate above xₑ and below −xₑ may be heated by conduction. Thus, the width of the heat affected zone may be the difference between x_{c} and xₑ plus a width of the substrate heated by conduction.

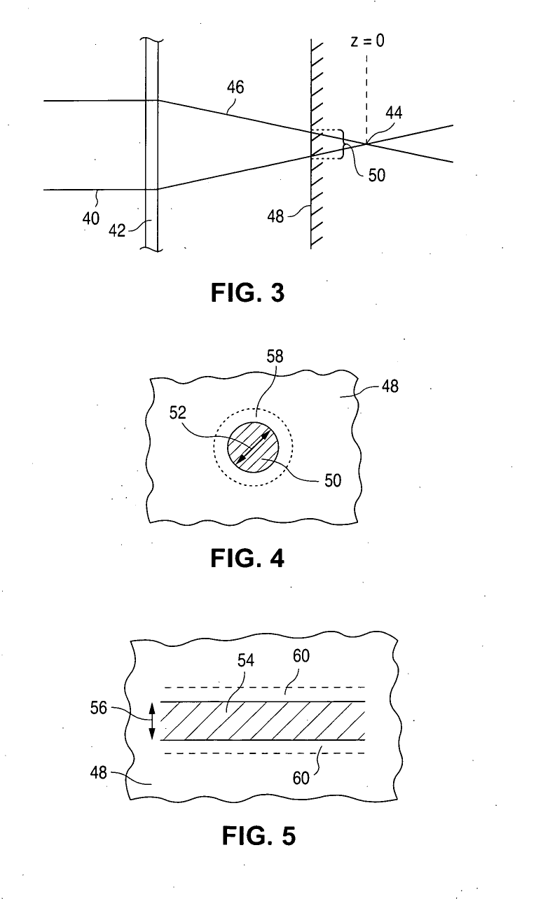

FIGS. 3-5 are schematic illustrations of laser machining a substrate. FIG. 3 depicts a collimated two-dimensional representation of a laser beam 40 passing through a focusing lens 42 with a focal point 44. A “collimated light beam” refers to a beam having parallel rays of light. A focused laser beam 46 decreases in diameter with distance from lens 42. Beam 46 impinges on a substrate 48. Area 50 corresponds to the region of direct interaction of the laser.

FIG. 4 depicts an overhead view of the surface of substrate 48 showing area 50 which has a diameter 52. Laser beam 40 removes material in area 50. Diameter 50 corresponds to a width of 2x_{c} from FIG. 2. FIG. 5 illustrates that translation of the laser beam, substrate, or both allows the laser beam to cut a trench or kerf 54 with a width 56 which is the same as diameter 52. No or substantially no material in regions 58 or 60 are removed. However, at least some material not removed is heated through direct interaction of the beam (e.g., between x_{c} and Xₑ and −x_{c} and −xₑ in FIG. 2) and by conduction. Regions 58 and 60 correspond to heat affected zones.

A heat affected zone in a target substrate is undesirable for a number of reasons. In both metals and polymers, heat can cause thermal distortion and roughness at the machined surface. The heat can also alter properties of a polymer such as mechanical strength and degradation rate. The heat can cause chemical degradation that can affect the mechanical properties and degradation rate.

Additionally, heat can modify the molecular structure of a polymer, such as degree of crystallinity and polymer chain alignment. Mechanical properties are strongly dependent on molecular structure. For example, a high degree of crystallinity and/or polymer chain alignment is associated with a stiff, high modulus material. Heating a polymer above its melting point can result in an undesirable increase or decrease in crystallinity once the polymer resolidifies. Melting a polymer may also result in a loss of polymer chain alignment, which can adversely affect mechanical properties.

In addition, since heat from the laser modifies the properties of the substrate locally, the mechanical properties may be spatially nonuniform. Such nonuniformity may lead to mechanical instabilities such as cracking.

As shown in FIG. 2, the gradual decrease in the intensity away from a center of the beam is responsible for the heat affected zone. The more gradual the decrease in the intensity between x_{c} and xₑ, the larger is the heat affected zone. Conversely, the less gradual or steeper the decrease in intensity between x_{c} and xₑ, the smaller the heat affected zone.

The heat affected zone can be reduced or eliminated by modifying or redistributing the intensity of a laser beam. Various embodiments of a method of fabricating an implantable medical device may include modifying an intensity of a laser beam with an optical system. The beam may be modified so that a heat affected zone adjacent to the material removed from a substrate machined by the beam is reduced or eliminated.

In some embodiments, a beam may be modified so that the portion of a radial cross-section of the beam having an intensity greater than a selected value is increased. The selected value of intensity may be a minimum intensity required for removal of the material from a desired substrate. In some embodiments, the modified intensity may be uniform or substantially uniform over a majority of a radial cross-section of the modified beam. In one embodiment, the modified intensity over the majority of the radial cross-section may be capable of removing material from the desired substrate. The method may further include removing material from a substrate with the modified beam to form an implantable medical device.

In one embodiment, the beam is modified so that an intensity adjacent to an edge of the beam decreases more steeply to zero than for the unmodified beam. In an embodiment, a diameter of the modified and unmodified laser beam may be equal or approximately equal.

In one embodiment, the method may include modifying a laser beam having a Gaussian-shaped radial intensity profile with an optical system to have a “flat-top” or a “top-hat” radial intensity profile. A “flat-top” or a “top-hat” radial intensity profile refers to a uniform or substantially uniform intensity over a majority of a radial cross-section of the beam. Such a profile also has an intensity that decreases steeply to zero adjacent to an edge of the beam.

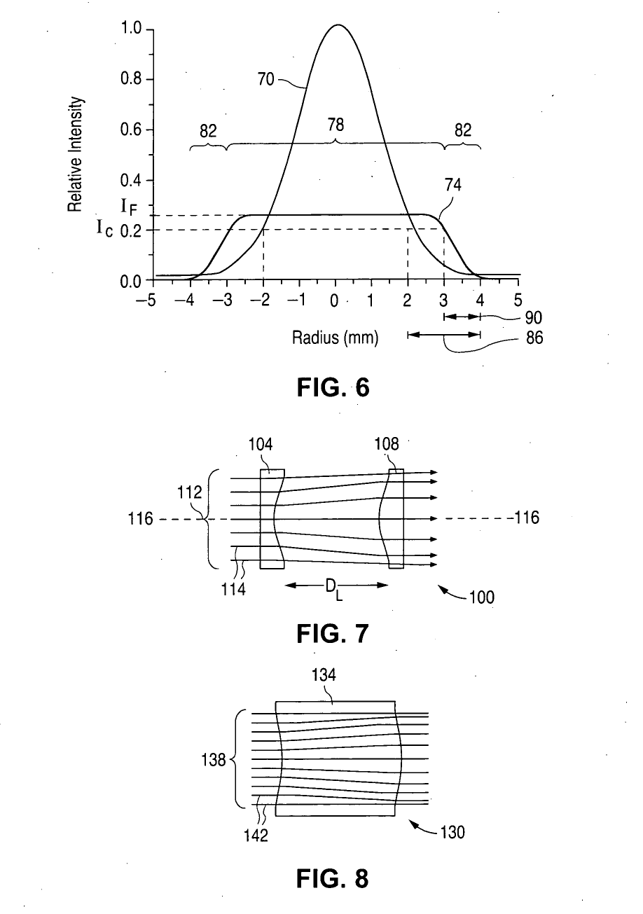

FIG. 6 depicts a Gaussian radial intensity profile 70 and a flat-top radial intensity profile 74. The intensity across a central portion 78 of flat-top profile 74 is substantially uniform with an intensity I_{F}. Edge regions 82 of flat-top profile 74 decrease steeply to zero. Laser machining a substrate with flat-top profile 74 results is a smaller heat affected zone than Gaussian profile 70. As shown in FIG. 2, I_{c} corresponds to a minimum intensity of the beam required to remove material from a desired substrate. The heat affected zone of a beam with Gaussian profile 70 has a minimum width 86 which is greater than a minimum width 90 of the heat affected zone resulting from a beam with flat-top profile 74. The heat affected zones for the two profiles can be larger than widths 86 and 90 due to transfer of heat by conduction to regions of the substrate that do not have direct interaction with the beam.

Furthermore, methods of generating a modified laser beam, e.g., a flat-top beam, as described above, are well know by persons of skill in the art of lasers and laser machining. Many methods and devices are available for producing a flat-top beam from a Gaussian beam. J. Hoffnagle and C. M. Jefferson, Appl. Opt. 39, 5488-5499 (2000). A flat-top beam can be produced using refractive or reflective optical systems, and diffractive elements. Converting Gaussian beams to flat-top beams can also be performed with absorptive elements. For example, a beam may be passed through filters with radially varying absorption profiles.

Methods that use diffractive elements have several disadvantages, such as wavelength sensitivity, low efficiency, and the need for extremely tight alignment tolerances of phase plates or holograms. Absorptive methods also have shortcomings. They have relatively modest efficiency, are sensitive to manufacturing tolerances in the absorptive element, and are restricted to relatively low laser power. In addition, reflective optics designs can have complicated asymmetric surfaces that pose fabrication problems.

On other hand, refractive methods for converting nonuniform beams to more uniform profiles have advantages over the other methods with respect to efficiency, alignment issues, fabrication, and range of applicability. J. Hoffnagle and C. M. Jefferson, Appl. Opt. 39, 5488-5499 (2000) Refractive methods are capable of high efficiency. Refractive methods have been disclosed that can produce a flat-top beam having 99.7% of the input beam intensity.

Additionally, refractive systems can have simple, coaxial optical arrangements which minimize alignment issues. Lens designs can be aspheric, but are rotationally symmetric and monotonic which greatly reduces difficulty in fabrication. The use of low dispersion optical materials in refractive methods allows a single design to function well from ultraviolet to infrared wavelengths. Therefore, a single grinding and polishing step can yield optics that can be used for a wide range of applications.

Refractive beam reshapers for converting Gaussian beams to flat-top beams may be obtained from Newport Corporation—Spectra-Physics Lasers Division in Mountainview, CA.

In certain embodiments, a refractive optical system may include at least one lens. A laser beam may be directed through one, two, three, or more lenses to modify the beam. In an embodiment, the optical system may redistribute the intensity of the laser beam to form the modified beam. The optical system can modify the beam so that the overall intensity of the modified beam is greater than 50%, 60, 70%, 80%, 90%, 95%, 98%, 99%, or 99.7%, of the unmodified beam.

FIG. 7 depicts an exemplary embodiment of a refractive optical system 100 for reshaping a Gaussian beam to a flat-top beam. Optical system 100 includes a first aspherical lens 104 and a second aspherical lens 108 separated by a distance D_{L}. A collimated beam 112, shown as rays 114, is directed at first aspherical lens 104. Light rays 114 are refracted by first aspherical lens 104. Light rays 114 are then recollimated as they pass through second aspherical lens 108. Since light rays 114 near an axis 116 of first aspherical lens 104 experience a larger radial magnification than those near the edge of lens 104, the irradiance across the beam is nonlinearly redistributed so that a uniform or substantially uniform flat-top profile is produced.

As indicated above, a refractive optical system is not limited to the use of two lenses or optical elements. In certain embodiments, an optical system for modifying a laser beam according to the embodiments described herein can include one or more lenses or optical elements. A single element laser beam shaper has been described in S. Zhang et al., Optics Express, 11, 1942-1948 (2003). The overall thickness of a single element design can be minimized which is an advantage for ultra-pulse applications.

FIG. 8 depicts an exemplary embodiment of a refractive optical system 130 for reshaping a Gaussian beam to a flat-top beam with a single aspheric lens 134. Collimated beam 138, shown as light rays 142, has a nonuniform spatial distribution. Light rays 142 are transformed by lens 134 to a collimated beam with a uniform flat-top distribution.

Representative examples of polymers that may be used to fabricate embodiments of implantable medical devices disclosed herein include, but are not limited to, poly(N-acetylglucosamine) (Chitin), Chitosan, poly(3-hydroxyvalerate), poly(lactide-co-glycolide), poly(3-hydroxybutyrate), poly(4-hydroxybutyrate), poly(3-hydroxybutyrate-co-3-hydroxyvalerate), polyorthoester, polyanhydride, poly(glycolic acid), poly(glycolide), poly(L-lactic acid), poly(L-lactide), poly(D,L-lactic acid), poly(D,L-lactide), poly(L-lactide-co-D,L-lactide), poly(caprolactone), poly(L-lactide-co-caprolactone), poly(D,L-lactide-co-caprolactone), poly(glycolide-co-caprolactone), poly(trimethylene carbonate), polyester amide, poly(glycolic acid-co-trimethylene carbonate), co-poly(ether-esters) (e.g. PEO/PLA), polyphosphazenes, biomolecules (such as fibrin, fibrinogen, cellulose, starch, collagen and hyaluronic acid), polyurethanes, silicones, polyesters, polyolefins, polyisobutylene and ethylene-alphaolefin copolymers, acrylic polymers and copolymers, vinyl halide polymers and copolymers (such as polyvinyl chloride), polyvinyl ethers (such as polyvinyl methyl ether), polyvinylidene halides (such as polyvinylidene chloride), polyacrylonitrile, polyvinyl ketones, polyvinyl aromatics (such as polystyrene), polyvinyl esters (such as polyvinyl acetate), acrylonitrile-styrene copolymers, ABS resins, polyamides (such as Nylon 66 and polycaprolactam), polycarbonates, polyoxymethylenes, polyimides, polyethers, polyurethanes, rayon, rayon-triacetate, cellulose acetate, cellulose butyrate, cellulose acetate butyrate, cellophane, cellulose nitrate, cellulose propionate, cellulose ethers, and carboxymethyl cellulose. Additional representative examples of polymers that may be especially well suited for use in fabricating embodiments of implantable medical devices disclosed herein include ethylene vinyl alcohol copolymer (commonly known by the generic name EVOH or by the trade name EVAL), poly(butyl methacrylate), poly(vinylidene fluoride-co-hexafluoropropene) (e.g., SOLEF 21508, available from Solvay Solexis PVDF, Thorofare, N.J.), polyvinylidene fluoride (otherwise known as KYNAR, available from ATOFINA Chemicals, Philadelphia, Pa.), ethylene-vinyl acetate copolymers, poly(vinyl acetate), styrene-isobutylene-styrene triblock copolymers, and polyethylene glycol.

Additionally, devices may also be composed partially or completely of biostable or bioerodible metals. Some metals are considered bioerodible since they tend to erode or corrode relatively rapidly when exposed to bodily fluids. Biostable metals refer to metals that are not bioerodible. Biostable metals have negligible erosion or corrosion rates when exposed to bodily fluids. Representative examples of biodegradable metals that may be used to fabricate devices may include, but are not limited to, magnesium, zinc, and iron. Biodegradable metals can be used in combination with biodegradable polymers.

Representative examples of metallic materials or alloys that may be used for fabricating an implantable medical device include, but are not limited to, cobalt chromium alloy (ELGILOY), stainless steel (316L), high nitrogen stainless steel, e.g., BIODUR 108, cobalt chrome alloy L-605, “MP35N,” “MP20N,” ELASTINITE (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from Standard Press Steel Co., Jenkintown, PA. “MP35N” consists of 35% cobalt, 35% nickel, 20% chromium, and 10% molybdenum. “MP20N” consists of 50% cobalt, 20% nickel, 20% chromium, and 10% molybdenum.

For example, a stainless steel tube or sheet may be Alloy type: 316L SS, Special Chemistry per ASTM F138-92 or ASTM F139-92 grade 2. Special Chemistry of type 316L per ASTM F138-92 or ASTM F139-92 Stainless Steel for Surgical Implants in weight percent. An exemplary weight percent may be as follows: Carbon (C): 0.03% max; Manganese (Mn): 2.00% max; Phosphorous (P): 0.025% max.; Sulphur (S): 0.010% max.; Silicon (Si): 0.75% max.; Chromium (Cr): 17.00-19.00%; Nickel (Ni): 13.00-15.50%; Molybdenum (Mo): 2.00-3.00%; Nitrogen (N): 0.10% max.; Copper (Cu): 0.50% max.; Iron (Fe): Balance.

In certain embodiments, a system for fabricating an implantable medical device may include a laser beam source that generates a beam having a nonuniform radial intensity profile. The system may also include a refractive optical system for modifying the beam. The refractive optical system may be capable of modifying the beam to have a more uniform radial intensity profile. In an embodiment, the system may also include a fixture for holding a substrate. The laser beam source may be positioned to direct the beam from the laser beam source through the optical system so that the modified beam removes material from the substrate held by the fixture.

FIG. 9 depicts an embodiment of a portion of a machine-controlled system for laser machining a tube. In FIG. 9, a tube 200 is disposed in a rotatable collet fixture 204 of a machine-controlled apparatus 208 for positioning tubing 200 relative to a laser 212. According to machine-encoded instructions, tube 200 is rotated and moved axially relative to laser 212 which is also machine-controlled. The laser selectively removes the material from the tubing resulting in a pattern cut into the tube. The tube is therefore cut into the discrete pattern of a finished stent.

The process of cutting a pattern for the stent into the tubing is automated except for loading and unloading the length of tubing. Referring again to FIG. 9, it may be done, for example, using a CNC-opposing collet fixture 204 for axial rotation of the length of tubing. Collet fixture 204 may act in conjunction with a CNC X/Y table 216 to move the length of tubing axially relative to a machine-controlled laser as described. The entire space between collets can be patterned using a laser set-up of the foregoing example. The program for control of the apparatus is dependent on the particular configuration used and the pattern formed.

Machining a fine structure also requires the ability to manipulate the tube with precision. CNC equipment manufactured and sold by Anorad Corporation in Hauppauge, New York may be used for positioning the tube. In addition, a unique rotary mechanism may be used that allows the computer program to be written as if the pattern were being machined from a flat sheet. This allows both circular and linear interpolation to be utilized in programming. Since the finished structure of the stent is very small, a precision drive mechanism is required that supports and drives both ends of the tubular structure as it is cut. Since both ends are driven, they must be aligned and precisely synchronized. Otherwise, the stent structure would twist and distort as it is being cut.

FIG. 10 depicts a general schematic of a laser system that may be used for laser machining of stents. FIG. 10 includes an active medium 250 within a laser cavity 254. An active medium includes a collection of atoms or molecules that are stimulated to a population inversion which can emit electromagnetic radiation in a stimulated emission. Active medium 250 is situated between a highly reflective mirror 258 and an output mirror 262 that reflects and absorbs a laser pulse between the mirrors. Arrows 260 and 266 depict reflected laser pulses with cavity 254. An arrow 274 depicts the laser pulse transmitted through output mirror 262. A power source 276 supplies energy or pumps active medium 250 as shown by an arrow 278 so that active medium 250 can amplify the intensity of light that passes through it.

A laser may be pumped in a number of ways, for example, optically, electrically, or chemically. Optical pumping may use either continuous or pulsed light emitted by a powerful lamp or a laser beam. Diode pumping is one type of optical pumping. A laser diode is a semiconductor laser in which the gain or amplification is generated by an electrical current flowing through a p-n junction. Laser diode pumping can be desirable since efficient and high-power diode lasers have been developed and are widely available in many wavelengths.

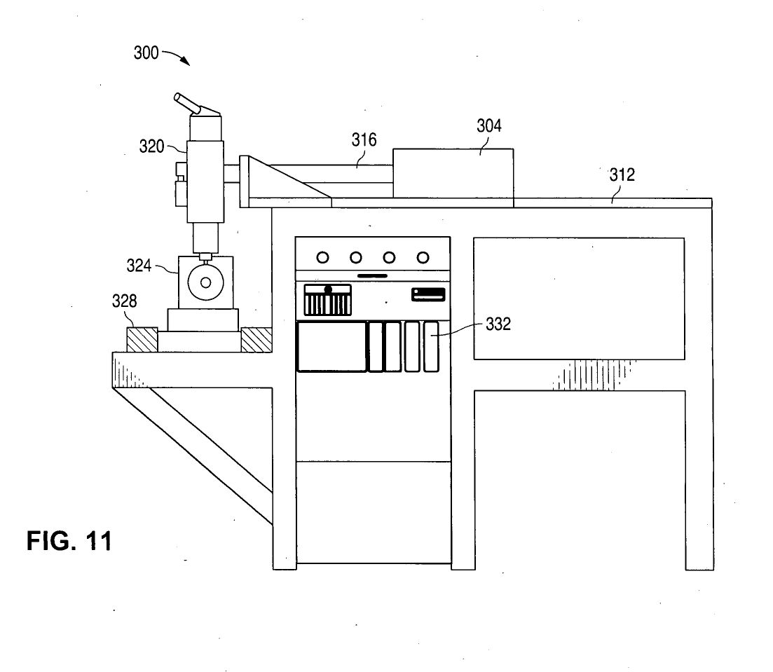

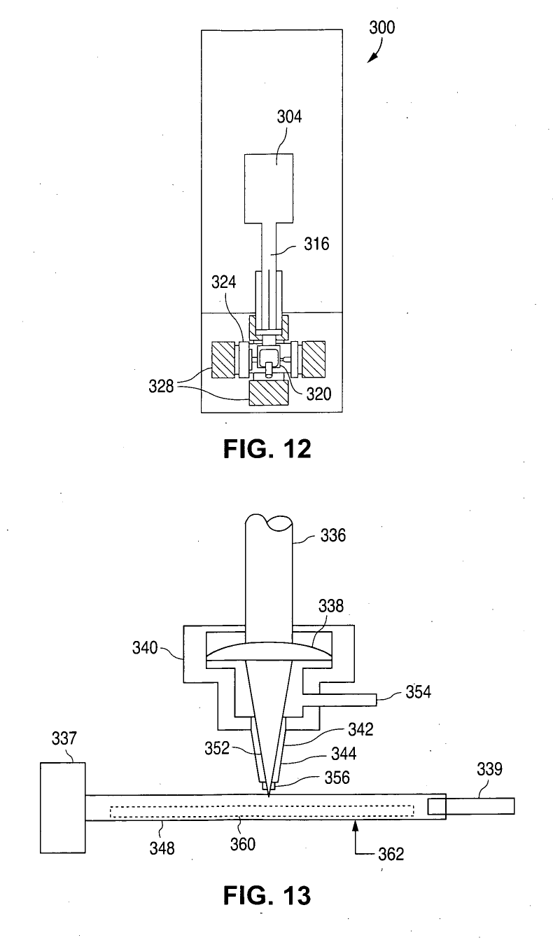

FIGS. 11-13 illustrate a process and apparatus, in accordance with the present embodiments, for producing stents with a fine precision structure cut from a small diameter thin-walled cylindrical tube. FIG. 11 depicts a side view of a laser machining apparatus 300 and FIG. 12 depicts an overhead view of apparatus 300. Cutting a fine structure (e.g., a 0.0035 inch strut width (0.889 mm)) requires precise laser focusing and minimal heat input. In order to satisfy these requirements, an improved laser technology has been adapted to this micro-machining application according to the present embodiments.

FIGS. 11 and 12 show a laser 304 (e.g., as shown in FIG. 10) that is integrally mounted on apparatus 300. A pulse generator (not shown) provides restricted and more precise control of the laser's output by gating a diode pump. By employing a pulse generator, laser pulses having pulse lengths between 10 and 500 femtoseconds are achieved at a frequency range of 100 to 5000 Hz. The pulse generator is a conventional model obtainable from any number of manufacturers and operates on standard 110 volt AC.

Laser 304 operates with low-frequency, pulsed wavelengths in order to minimize the heat input into the stent structure, which prevents thermal distortion, uncontrolled burn out of the stent material, and thermal damage due to excessive heat to produce a smooth, debris-free cut. In use, a diode pump generates light energy at the proximal end of laser 304. Initially, the light energy is pulsed by the pulse generator. The pulsed light energy transmissions pass through beam tube 316 and ultimately impinge upon the workpiece.

Additionally, FIGS. 11 and 12 show that apparatus 300 incorporates a monocular viewing, focusing, and cutting head 320. A rotary axis 324 and X-Y stages 328 for rotating and translating the workpiece are also shown. A CNC controller 332 is also incorporated into apparatus 300.

FIG. 13 depicts a close-up axial view of the region where the laser beam interacts with the substrate target material. A laser beam 336 is focused by a focusing lens 338 on a tube 348. Tube 348 is supported by a CNC controlled rotary collet 337 at one end and a tube support pin 339 at another end.

As shown by FIG. 13, the laser can incorporate a coaxial gas jet assembly 340 having a coaxial gas jet 342 and a nozzle 344 that helps to remove debris from the kerf and cools the region where the beam interacts with the material as the beam cuts and vaporizes a substrate. Coaxial gas jet nozzle 344 (e.g., 0.018 inch diameter (0.457 mm)) is centered around a focused beam 352 with approximately 0.010 inch (2.54 mm) between a tip 356 of nozzle 344 and a tubing 348. In certain embodiments, an optical system for modifying a laser beam according to the embodiments described herein may be positioned between cutting head 320 and the substrate target material.

It may also be necessary to block laser beam 352 as it cuts through the top surface of the tube to prevent the beam, along with the molten material and debris from the cut, from impinging on the inside opposite surface of tubing 348. To this end, a mandrel 360 (e.g., approx. 0.034 inch diameter (0.864 mm)) supported by a mandrel beam block 362 is placed inside the tube and is allowed to roll on the bottom of the tube 348 as the pattern is cut. This acts as a beam/debris block protecting the far wall inner diameter. A close-up end view along mandrel beam block 362 shows laser beam 352 impinging on tube 348 in FIG. 14.

Hence, the laser of the present invention enables the machining of narrow kerf widths while minimizing the heat input into the material. Thus, it is possible to make smooth, narrow cuts in a tube with very fine geometries without damaging the narrow struts that make up the stent structure.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

1. A method of fabricating an implantable medical device, comprising:
modifying a laser beam having a Gaussian-shaped radial intensity profile with an optical system to have a flat-top radial intensity profile; and
removing material from a substrate with the modified beam to form an implantable medical device.

2. The method of claim 1, wherein the implantable medical device is a stent.

3. The method of claim 1, wherein the optical system comprises a refractive optical system.

4. The method of claim 1, wherein the substrate comprises a biodegradable and/or biostable polymer.

5. The method of claim 1, wherein an intensity of the flat-top profile across a majority of the profile is capable of removing material from the substrate.

6. The method of claim 1, wherein the laser beam is a femtosecond laser beam.

7. The method of claim 1, wherein the substrate comprises a tubular member and removing the material forms a stent comprising a plurality of structural elements.

8. The method of claim 1, wherein the beam is modified so that a heat affected zone adjacent to the removed material on the substrate is reduced or eliminated.

9. The method of claim 1, wherein modifying the laser beam comprises directing the laser beam through the optical system, the optical system redistributing intensity of the laser beam to form the flat-top radial intensity profile.

10. The method of claim 1, wherein the optical system comprises at least one lens that redistributes the intensity of the laser beam to form the modified beam having the flat-top radial intensity profile.

11. A method of fabricating an implantable medical device, comprising:
modifying an intensity of a laser beam with an optical system, wherein the modified intensity is uniform or substantially uniform over a majority of a radial cross-section of the modified beam; and
removing material from a substrate with the modified beam to form an implantable medical device.

12. The method of claim 11, wherein the implantable medical device is a stent.

13. The method of claim 11, wherein the optical system comprises a refractive optical system.

14. The method of claim 11, wherein the substrate comprises a biodegradable and/or biostable polymer.

15. The method of claim 11, wherein the modified intensity across the majority of the radial cross-section is capable of removing material from the substrate.

16. The method of claim I 1, wherein the laser beam is a femtosecond laser beam.

17. The method of claim 11, wherein the substrate comprises a tubular member and removing the material forms a stent comprising a plurality of structural elements.

18. The method of claim 11, wherein the optical system comprises at least one lens that redistributes the intensity of the laser beam to form the modified beam.

19. The method of claim 11, wherein the intensity of the modified beam adjacent to an edge of the beam decreases more steeply to zero than the unmodified beam.

20. The method of claim 11, wherein a radial intensity profile of the unmodified laser beam comprises a Gaussian-shaped radial profile.

21. The method of claim 11, wherein a radial profile of the modified laser beam comprises a flat-top-shaped radial profile.

22. The method of claim 11, wherein the beam is modified so that a heat affected zone adjacent to the removed material on the substrate is reduced or eliminated.

23. A method of fabricating an implantable medical device, comprising:
modifying an intensity of a laser beam with an optical system so that a portion of a radial cross-section of the beam having an intensity greater than a selected value is increased; and
removing material from a substrate with the modified beam to form an implantable medical device.

24. The method of claim 23, wherein the implantable medical device is a stent.

25. The method of claim 23, wherein the optical system comprises a refractive optical system.

26. The method of claim 23, wherein the substrate comprises a biodegradable and/or biostable polymer.

27. The method of claim 23, wherein the selected value of intensity is a minimum intensity that is capable of removing the material from the substrate.

28. The method of claim 23, wherein the portion of the modified beam comprises a majority of a radial cross-section of the modified bean.

29. The method of claim 23, wherein the portion of the modified beam comprises a uniform or substantially uniform intensity.

30. A system for fabricating an implantable medical device, comprising:
a laser beam source that generates a beam having a nonuniform radial intensity profile;
a refractive optical system for modifying the beam, wherein the refractive optical system is capable of modifying the beam to have a more uniform radial intensity profile; and
a fixture for holding a substrate, wherein the laser beam source is positioned to direct the beam from the laser beam source through the optical system so that the modified beam removes material from the substrate held by the fixture.

31. The system of claim 30, wherein the laser beam source is a femtosecond laser.

32. The system of claim 30, wherein the laser beam generated by the laser source has a Gaussian radial intensity profile and the modified laser beam has a flat-top radial intensity profile.

33. The method of claim 1, wherein the optical system redistributes the intensity of the beam from a central radial portion of the beam to an outer radial portion of the beam.

34. The method of claim 11, wherein the optical system decreases the intensity in a central radial portion of the beam and increases the intensity in an outer radial portion of the beam.

35. The method of claim 23, wherein the beam is modified so that a central portion of the beam has a greater degree of refraction than an outer radial portion of the beam.

36. The system of claim 30, wherein the optical system redistributes the intensity of the beam from a central radial portion of the beam to an outer radial portion of the beam.
